(19) United States
(12) Patent Application Publication
(10) Pub. No.: US 2026/0058512 A1
(43) Pub. Date: Feb. 26, 2026

(54) Electric Motor

(71) Applicant: Innomotics GmbH, Nürnberg (DE)

(72) Inventors: Frank Brütting, Erlangen (DE); Markus Hösle, Erlangen (DE); Jonathan Robinson, Eindhoven (NL)

(73) Assignee: Innomotics GmbH, Nürnberg (DE)

(21) Appl. No.: 18/996,231

(22) PCT Filed: Apr. 26, 2023
(86) PCT No.: PCT/EP2023/060933

§ 371 Date: Jan. 17, 2025

(30) Foreign Application Priority Data
Jul. 20, 2022 (EP) 22185951.5

(51) Int. Cl. H02K 3/24; H02K 3/22

(52) U.S. Cl. CPC H02K 3/24; H02K 3/22

(57) ABSTRACT

Various embodiments of the teachings herein include an electric motor. An example includes: a stator with a plurality of bar-shaped field conductors; and an inverter with one or more parallel power components for controlling each of the field conductors, wherein the inverter comprises a controller to generate control signals for the power components. Power amplifiers are arranged on a plurality of circuit boards. The individual circuit boards are arranged on one or more cooling plates. The one or more cooling plates are arranged in mechanically active connection with the field conductors. A cooling device including a fluid line routed at least in part inside one of the field conductors.

### CROSS-REFERENCE TO RELATED APPLICATIONS

This application is a U.S. National Stage Application of International Application No. PCT/EP2023/060933 filed Apr. 26, 2023, which designates the United States of America, and claims priority to EP Application No. 22185951.5 filed Jul. 20, 2022, the contents of which are hereby incorporated by reference in their entirety.

### TECHNICAL FIELD

The present disclosure relates to electric motors. Some embodiments of the teachings herein include electric motors with stator-side field conductors in the form of a bar.

### BACKGROUND

Electric motors may have a stator with a series of bars instead of wound wire conductors as field conductors. The bars have a low inductance compared to conventional windings. Hence a comparatively high current flow is necessary for the generation of a specified magnetic field. However, this high current flow requires only a comparatively low voltage of 12 V for example, due to the low inductance of the bars. The low voltage makes it possible to arrange the components of the inverters, with which the bars are controlled, at small distances from one another. Thus, the components of the power electronics can for example be arranged on one or more printed circuit boards, which are arranged close to the electric motor. The bars can in this case be used directly or via electrically conductive bar-like connecting elements directly as mechanical supports for the printed circuit boards.

In addition to the high heat loss of the electrical and electronic components, which is caused by the high current intensities, there is also a high packing density of the electrical and electronic components in an electric motor designed in this way. Their direct connection to the stator/rotor block via the bars ensures a further heat input from the stator/rotor block. This results a considerable cooling effort for the electrical and electronic components on the printed circuit boards.

### SUMMARY

Teachings of the present disclosure include electric motors which may avoid these trade-offs. For example, some embodiments include an electric motor (10) having: a stator (11) with a plurality of field conductors (12) in the form of a bar, an inverter with one or more parallel power components for controlling each of the field conductors (12), wherein the inverter comprises a controller for generating control signals for the power components, wherein the power amplifiers of the inverter are arranged on a plurality of circuit boards (15), the circuit boards (15) are arranged on at least one cooling plate (16), the cooling plate (16) is arranged such that the field conductors (12) or current conductors (18) arranged on the field conductors (12) and axially extending them are in mechanically active connection with the cooling plate, and at least one cooling device is present, which comprises a fluid line (20) which is routed at least in part inside one of the field conductors (12) and/or current conductors (18).

In some embodiments, a fluid line (20) is present for each of the field conductors (12) and/or current conductors (18) and is routed at least in part inside the field conductor (12) and/or current conductor (18).

In some embodiments, a region (19) in which the fluid line (20) is routed in the field conductor (12) and/or current conductor (18) is located axially between a cooling plate (16) and an axial beginning of the stator/rotor block (8).

In some embodiments, the electric motor (10) has a short-circuiting ring (38) on the side of the electric motor (10) facing away from the cooling plates (16) for the electrical connection of the field conductors (12) and in which the fluid lines (20) for at least two of the field conductors (12) are connected to one another in the short-circuiting ring.

In some embodiments, the fluid lines (20) for at least two of the field conductors (12) are connected to one another on a side of the electric motor facing away from the short-circuiting ring (38). In some embodiments, the fluid line (20) is formed in part by a threaded rod (27), which is screwed into an end of a field conductor (12), wherein the fluid line (20) is continued in the field conductor (12).

In some embodiments, one or more cooling plates (16) are slid onto the threaded rod (27) in alternation with elements for axial positioning, in particular spacing sleeves, (25, 28).

In some embodiments, the fluid line (20) has a metallic material, in particular consists of a metallic material.

In some embodiments, the fluid line (20) is formed by a cavity or bore in the field conductor (12) and/or current conductor (18).

In some embodiments, the fluid line (20) is a heat tube (30) and is arranged entirely inside one of the field conductors (12) and/or current conductors (18) and/or a short-circuiting ring (38) connected to the field conductor (12).

In some embodiments, a capacitor-side end of the heat tube (30) is arranged in the short-circuiting ring g (38) and the short-circuiting ring (38) is formed from spaced laminations.

In some embodiments, the circuit boards (15) are designed in the shape of a circle or a ring sector.

In some embodiments, the cooling plate (16) is arranged perpendicular to the axis (9) of the electric motor (10).

In some embodiments, the electric motor (10) is designed to control each of the field conductors (12) with a separate phase.

In some embodiments, the inverters are designed to generate an A/C voltage with an amplitude of 200 V or less, in particular 150 V or less, in particular 50 V or less.

### BRIEF DESCRIPTION OF THE DRAWINGS

The teachings are described and explained in greater detail below using the exemplary embodiments represented in the figures, in which, shown schematically:

FIG. 1 shows an example electric motor incorporating teachings of the present disclosure with power components arranged on circuit boards supported by cooling plates, in an oblique view;

FIG. 2 shows printed circuit boards arranged on a cooling plate incorporating teachings of the present disclosure in a front view;

FIG. 3 shows a cutout of the electric motor in an oblique view with cooling plates with circuit boards;

FIG. 4 shows a sectional view of a conductor bar with a cooling plate that has been slid on and with fluid channel and hose connection incorporating teachings of the present disclosure;

FIG. 5 shows a sectional view of a conductor bar with three cooling plates that have been slid on and with fluid channel and hose connection incorporating teachings of the present disclosure;

FIG. 6 shows the routing of fluid channels to the front and rear side of the electric motor incorporating teachings of the present disclosure;

FIG. 7 shows a sectional view of an example electric motor with heat tubes as fluid channels incorporating teachings of the present disclosure; and

FIG. 8 shows a cutout of the end face of an example electric motor incorporating teachings of the present disclosure with a laminated short-circuiting ring.

### DETAILED DESCRIPTION

Some embodiments of the teachings herein include an electric motor with a stator having a plurality of field conductors in the form of a bar and an inverter with one or more parallel power components for controlling each of the field conductors, wherein the inverter comprises a controller for generating control signals for the power components. In this case the power amplifiers of the inverter are arranged on a plurality of circuit boards and the circuit boards on at least one cooling plate, wherein the cooling plate is arranged such that the field conductors or current conductors arranged on the field conductors and axially extending them are in mechanically active connection with the cooling plate. At least one cooling device is present, which comprises a fluid line which is routed at least in part inside one of the field conductors and/or current conductors.

Thanks to the cooling device, the electric motor has an improved heat dissipation for the field conductors. This results in a smaller heat flow to the cooling plates and the electronics arranged on the cooling plates, in particular the inverters. As a result, the cooling effort in the region of the cooling plates and the electronics can in turn be reduced.

In some embodiments, the field conductors or current conductors act as mechanical supports for the cooling plates and hence are in mechanically active connection therewith. It is possible for the field conductors or current conductors to penetrate the cooling plate and the circuit board.

In some embodiments, the fluid lines can be water lines. Water is a standard coolant and can for example be made available in a plant from outside the electric motor, so that lines suitable for water are expedient.

In some embodiments, the electric motor can be designed to use an electrically conductive fluid as a coolant, wherein the specific conductivity is at least 10⁻² S/m, in particular at least 1 S/m. If the cooling fluid is electrically conductive, this means a further current path is provided in the fluid line which would not otherwise be present. As a result, for a given current flow through the field conductor or current conductor, the cross-section of a metallic conductor, for example copper, which has to be provided for the current is reduced and thus material and weight are saved.

In some embodiments, the electric motor can be designed to use air as a cooling fluid. Compared to other media, air has the advantage of having low structural requirements, since air does not have to be enclosed and sealed off from the structures to be cooled. Instead, air can be routed in open cooling channels and is freely available.

In some embodiments, the electric motor can have a pump for a cooling fluid. If the cooling fluid is not supplied from outside, it is advantageous if the electric motor is designed such that a circulation of fluid can be generated, which ensures heat dissipation due to material movement. If the motor has a large number of field conductors, for example more than 50 or even more than 100 field conductors, multiple pumps may also be present.

In some embodiments, the electric motor can be designed so that for each of the field conductors and/or current conductors a fluid line is present and is routed at least in part inside the field conductor and/or current conductor. It is expedient to provide cooling for each of the field conductors or current conductors, since in operation of the electric motor the field conductors or current conductors are equally exposed to heat and thus each of the field conductors or current conductors contributes approximately equally to the heat transfer to the cooling plates.

In some embodiments, a region in which the fluid line is routed in the field conductor and/or current conductor is expediently located axially between a cooling plate and an axial beginning of the rotor. It is further expedient to dissipate the heat in this region, in order to reduce the heat input from the rotor region, i.e. from the drive system into the electronics, i.e. from the region of the cooling plates and circuit boards.

If current conductors are present, they may be connected to the field conductors by means of a shoe, wherein the fluid line can also be routed in the shoe. The shoe serves for the permanent connection between the field conductors and the current conductors, wherein the field conductors belong to the drive side of the electric motor and the current conductors contact the electronics on the circuit boards and support the cooling plates and circuit boards.

In some embodiments, the electric motor can have a short-circuiting ring for the electrical connection of the field conductors. The fluid lines for at least two of the field conductors can be connected to one another in the short-circuiting ring. This makes it advantageous to connect the fluid lines in series on one side of the electric motor, so that the inflow and outflow are located on one side of the electric motor. It is expedient to connect the fluid lines together in pairs in the short-circuiting ring.

If the fluid lines are connected in pairs on the end face of the electric motor in the short-circuiting ring, it can be advantageous also to connect some of the fluid lines on the rear face of the electric motor. The fluid lines may be connected in blocks of at least two fluid lines in this case, such that a meandering course of the resulting connected fluid lines through the stator is achieved. This reduces the number of inflows and outflows and thus simplifies the structure of the electric motor. In principle, the number of inflows and outflows can be reduced to one in each case by connecting all the fluid lines in series. In certain embodiments of the motor, it can be expedient to use more than one outflow and inflow each, i.e. to connect the fluid lines serially in blocks only.

In some embodiments, connected fluid lines are spaced apart from one another such that they do not belong to adjacent conductor bars. For example, the fluid line of each n-th conductor bar can be connected in series, where n is at least two. Thus if n=2 a fluid line of a first conductor bar is connected to that of a next but one (third) conductor bar. Then for example n fluid channel paths that consist of connected fluid lines and are separate from one another can be present. If one of the fluid channel paths fails, the lack of cooling does not affect a contiguous block of conductor bars, but is distributed evenly over the circumference of the electric motor.

In some embodiments, the fluid line can be formed at least in part by a cavity or bore in the field conductor and/or power line. In principle, the fluid line then has no material of its own, as it is not a separate component. In some embodiments, the fluid line can be a separate component. In this case, the fluid line can have a metallic material, in particular can be metallic. As a result, the fluid line itself, and possibly also the cooling fluid, may be available as an electrical conductor.

The fluid line can also have a ceramic material, in particular can consist of a ceramic material. Ceramic materials are heat-resistant, chemically resistant and electrically insulating and as a result may be advantageous in particular embodiments of the electric motor.

In some embodiments, the fluid line can be a heat tube or thermosiphon. It may be arranged entirely inside one of the field conductors and/or current conductors. Due to the enormously high thermal conductivity of a heat tube a strong cooling of the field conductor or current conductor is achieved in the region of the evaporator side of the heat tube. The evaporator side of the heat tube may be arranged in the region of the cooling plates and circuit boards or between these and the stator/rotor block. As a result, this prevents or reduces waste heat from the stator/rotor block from additionally heating the cooling plates and circuit boards via the field conductors. The capacitor side of the heat tubes can be arranged on one side away from the stator/rotor block and on the other side of the cooling plates. In some embodiments, the capacitor end can also be arranged in the region of a short-circuiting ring of the electric motor. In this case, the heat tube can also extend into the short-circuiting ring.

In the region of the capacitor end of the heat tube it is expedient if good heat dissipation is enabled, by cooling fins being present for example. If the capacitor end of the heat tube is located in the region of the short-circuiting ring, the short-circuiting ring can for example be laminated in structure, wherein the individual laminations can be spaced apart. This means the short-circuiting ring has a large surface and thus enables efficient heat dissipation. This can be supported by forced air movement, for example by an internal or external fan.

In some embodiments, the electric motor can have a plurality of circuit boards. In particular, a plurality of separate circuit boards can be affixed to a cooling plate. By being distributed over a plurality of circuit boards the power electronics used can be modularized. Thus by using a large number of similar circuit boards a plurality of converters can be provided, meaning that production is improved in terms of rejects.

In some embodiments, the circuit boards can be designed in the shape of a circle or a ring sector. The circuit boards can as a result be arranged in a circle or ring which surrounds the axis of the electric motor. Circuit boards with this shape can be assembled into a circle or ring and thus arranged at an axial end of the machine, optimally adapted to the shape of the electric machine, wherein at the same time a high degree of modularity is achieved. The circuit boards can as a result be arranged axially offset to the stator and rotor to save space and form an integral part of the electric motor. In this way, it is also possible to arrange multiple cooling plates with circuit boards axially offset to each other and thus for example to connect inverters in parallel which are arranged at the same azimuthal position.

In some embodiments, the cooling plate is arranged perpendicular to the axis of the electric motor. In this way, the cooling plate with the circuit boards can be arranged at an axial end of the electric machine to save space. A plurality of cooling plates can also be arranged axially offset and close to one another. Furthermore, in such an arrangement, there is an equal distance between cooling plate and power electronics and the bars that form the field conductors, as a result of which the contacting of the bars is simplified.

In some embodiments, each of the field conductors is controlled with its own phase. A phase is understood here as a supply of alternating current, which compared to all other phases used in the electric motor is phase-shifted by an angle different from zero. In this case a separate inverter which controls only this field conductor is expediently present for each of the field conductors.

In some embodiments, the inverters can be designed to generate an A/C voltage with an amplitude of 200 V or less, in particular 150 V or less, in particular 50 V or less. The voltage generated in this way is the voltage applied to the field conductors, i.e. the stator bars. Thanks to this comparatively low voltage it is possible for the components of the inverters to be arranged very close to one another. Distances of about 2 mm between the components such as the power semiconductor switches can be used, which results in a high packing density of the electronic components and the possibility of arranging a plurality of inverters in a comparatively small space. As a result, it is possible to use a large number of phases, in particular a number of phases that corresponds to the number of stator bars, while taking up little space. Thus 48, 72 or even 120 phases can be used with a correspondingly high number of stator bars.

The terms “axial”, “radial”, “azimuthal” in this case relate to the axis of the rotor and thus to the corresponding axis of symmetry of the stator. In this case “axial” describes a direction parallel to said axis, “radial” describes a direction orthogonal to the axis, toward or else away from it, and “azimuthal” is a direction which is arranged at a constant radial distance from the axis and in a constant axial position in a circle around the axis.

If the terms “axial”, “radial” and “tangential” are used in respect of a surface, for example a cross-section surface, the terms describe the orientation of the normal vector of the surface, i.e. of the vector which is perpendicular to the surface in question.

In some embodiments, the electric motor can be used in applications in which a high power of 10 kW or more, in particular 100 kw or more, and in special embodiments 1 MW or more, which can be controlled over a wide torque range and power range, is required. The electric motor is also advantageously where a compact structure is required. Examples of areas of application are marine drives from small boats up to large ships, motor vehicles, pumps, fans, centrifuges in the industrial sector; transportation and the food industry.

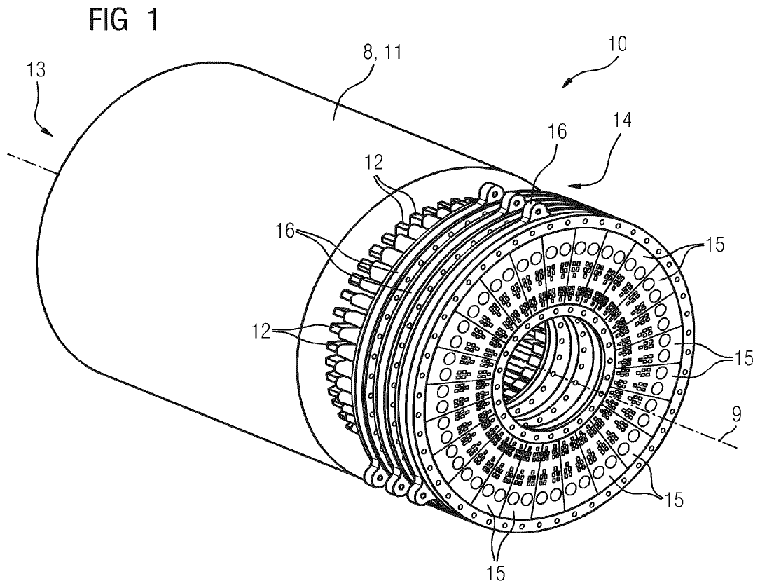

FIG. 1 shows an isometric view of an example electric motor 10 incorporating teachings of the present disclosure. The electric motor 10 comprises a stator 11 and a rotor, which is substantially arranged in the stator 11 and is not visible in FIG. 1. The rotor is connected to rotate with a shaft, which is likewise not shown in FIG. 1. Due to electromagnetic interaction between the rotor and the energized stator 11, the rotor is caused to rotate about an axis 9. In this case the rotor is separated from the stator 11 by an air gap. In other forms of embodiment, the electric motor 10 can also be an external rotor motor or a bell-type armature motor.

The stator 11 comprises a plurality of rigid and straight conductor bars 12 as field conductors. These conductor bars 12 are connected to one another via a short-circuiting ring 38 on the end face 13 facing away in FIG. 1. On the rear face 14 of the electric motor 10, the conductor bars 12 are fed individually by associated inverter modules in each case. Since due to the conductor bars 12 the electric motor 10 is operated at low voltages, the inverter modules can be arranged relatively close together on circuit boards 15 together with other components the electronics (DC/DC converter, rectifier). In this example, the circuit boards 15 are ring-sector-shaped and many individual circuit boards 15 together form a ring-shaped printed circuit board structure.

While it is assumed in the examples that the circuit boards 15 at least support the power components of inverters, it is also possible for some circuit boards 15 to support rectifiers and DC/DC converters.

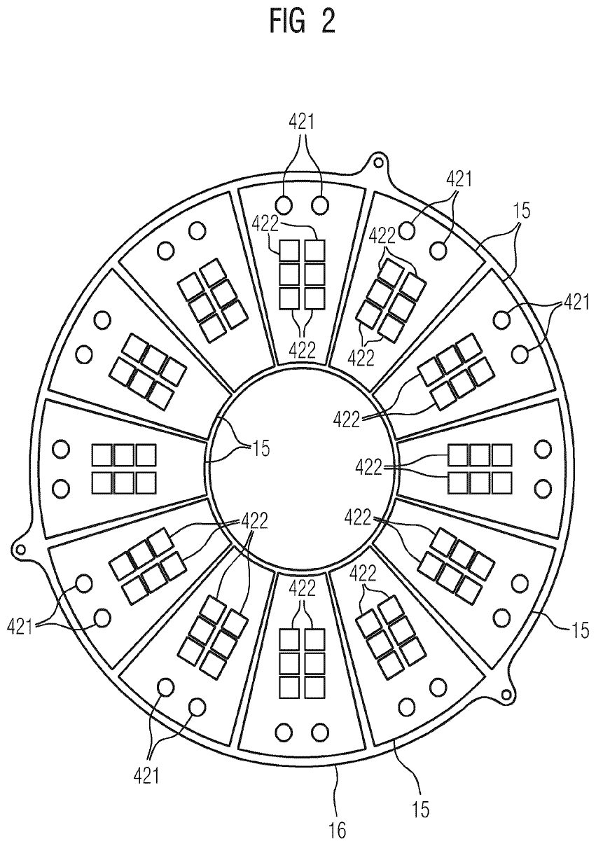

FIG. 2 shows a top view of such a printed circuit board structure incorporating teachings of the present disclosure. For greater clarity, the number of printed circuit boards represented in FIG. 2 is reduced and greatly simplified compared to the representation in FIG. 1. The actual number of such circuit boards 15 depends on the actual design of the electric motor 10, in particular the number of conductor bars 12. Each of the circuit boards 15 comprises multiple semiconductor switches 422. The semiconductor switches 422 together form power components of inverters, which provide an AC voltage for the conductor bars 12.

Furthermore, some of the circuit boards 15 or all the circuit boards 15 may comprise driver circuits not shown in the figures and other electronic components such as capacitors. The semiconductor switches 422 are power semiconductors such as for example IGBTs, MOSFETs or JFETs and, depending on the interconnection, may additionally comprise diodes (not shown). The semiconductor switches 422 are for example connected as half-bridges. A capacitor (not shown) can for example represent an intermediate circuit capacitor of the half-bridges. The semiconductor switches 422 of a circuit board 15 can in this case be assigned to a single phase. In the case of an electric motor 10 with a large number of field conductors 12 and a corresponding number of phases it is advantageous if a circuit board 15 supports the power components for multiple phases.

The circuit boards 15 further comprise contact points 421, to which the conductor bars 12 are connected. The circuit boards 15 are supported by disk-shaped cooling plates 16, wherein for a better use of space the cooling plates 16 can be populated on both sides with circuit boards 15.

Since the electric motor 10 requires relatively high currents in the conductor bars, it may be preferable to connect multiple power components in parallel to supply them with current. This can be achieved for example by the six printed circuit board structures shown in FIG. 1 on three cooling plates 16 all being connected in the same way to the conductor bars 12 and thus electrically connected in parallel. This takes advantage of the fact that the conductor bars 12 or connecting elements 18 to the conductor bars 12 penetrate the cooling plates 16 and thus also the circuit boards 15 in the same way at the contact points or in the case of the outermost cooling plate 16 at least make contact.

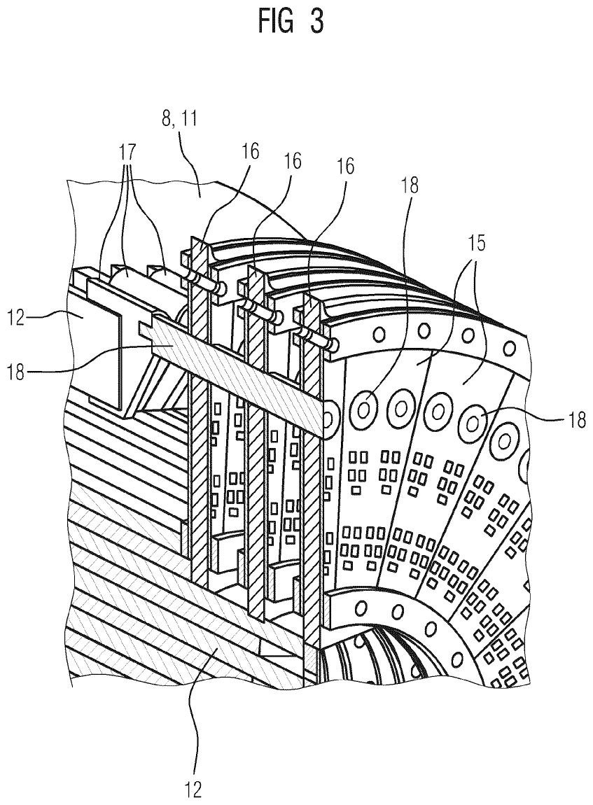

FIG. 3 shows a sectional view of the electric motor 10 in an oblique view. It can be seen here that the connecting elements 18 mechanically support and penetrate the three cooling plates 16. The connecting elements 18 are connected to the conductor bars 12 via shoes 17. The power amplifiers, which are located on the circuit boards 15 in the regions in which one of the connecting elements 18 penetrates a cooling plate 16, are connected in parallel and together provide the current for the conductor bar 12. In the structure shown in FIG. 3 it can be seen that two of the connecting elements 18 each pass through a circuit board 15. Thus each of the printed circuit boards supports the power amplifiers for two phases of the electric motor 10. In other variants of the electric motor 10, a single circuit board 15 may also support only one phase or three or more phases, wherein the same number of connecting elements 18 pass through the circuit board 15.

The stator/rotor block 8 of the electric motor 10 and the electronics on the circuit boards 15 generate heat. The conductor bars 12 and the connecting elements 18 represent not only the electrical line but also a heat bridge between both the components. However, particularly on the electronics side it is important that the additional heat input that occurs is not too large, since the electronic components must not greatly exceed a temperature of approx. 80° C. for long. However, increased cooling in the region of the circuit boards is expensive.

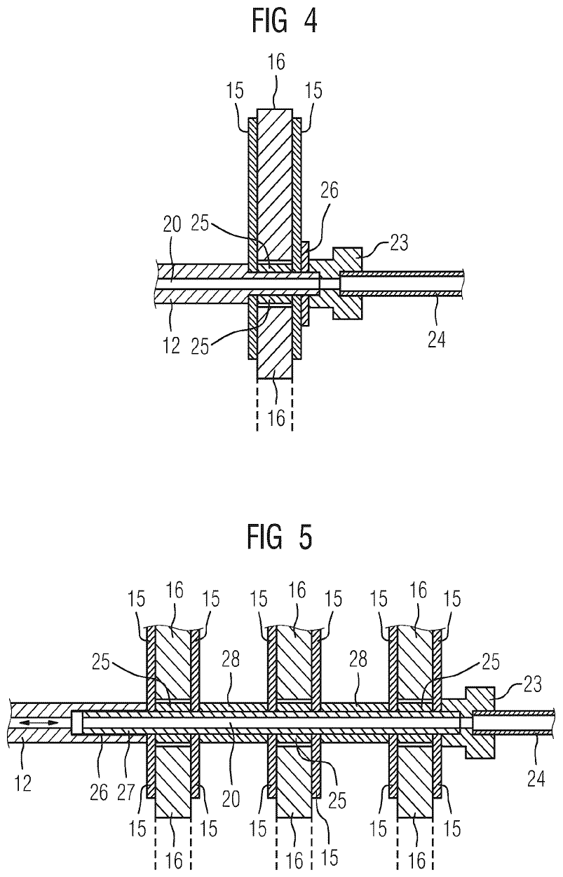

FIG. 4 shows a sectional view of a cutout of the electric motor 10. The sectional view shows two circuit boards 15, which are arranged on both sides of a cooling plate 16. The arrangement in FIG. 4 corresponds to that in FIGS. 1 to 3. Hence the sectional view in FIG. 4 only shows two of the circuit boards 15 from the ring structure that forms the circuit boards 15. The cooling plate 16 is slid onto a conductor bar 12 and is supported by the conductor bars 12. To enable the cooling plate 16 to be slid onto the conductor bar 12, the latter is tapered toward the end. A metallic sleeve 25 creates an enlarged conductor cross-section between the circuit boards 15, i.e. the front and rear of the cooling plate 16, in the region of the taper. The cooling plate and the circuit boards 15 can for example be fixed by means of a nut 26. To this end, it is expedient if the conductor bar 12 has an external thread in the end region.

The conductor bars 12 each comprise a fluid channel 20, for example in the form of a bore. The fluid channel 20 is continuous and ends at the external end of the conductor bar 12. A hose connection 23 can be attached there, producing a connection to a hose 24. The hose 24 and fluid channel 20 allow a cooling fluid, for example air or water, to flow through the conductor bars 12 and thus to dissipate heat. In this case it is possible to guide the fluid channel 20 out of the conductor bar 12 at another position in order to achieve a second connection, i.e. an outflow.

The structure shown in FIG. 4 can be extended in order to connect more than one cooling plate 16. A corresponding structure is shown in FIG. 5. In this embodiment, the end of the conductor bar 12 has a recess 26 toward the end, which in this example has an expanded diameter compared to the fluid channel 20. The recess 26 is provided with an internal thread. A threaded bar 27 is screwed into the recess 26. The threaded bar 27 in turn has a fluid channel 20 which, when screwed in, continues the fluid channel 20 of the conductor bar 12.

A sequence of three cooling plates 16 with the respective circuit boards 15 is then slid onto the threaded bar 27 in the example in FIG. 5. Sleeves 25, 28 are inserted to ensure current conduction by the correct spacings between the circuit boards 15 under the pressure required for contacting and also for electrical conduction. A hose connection 23, which connects the fluid channel 20 to a hose 24, is arranged at the end of the threaded rod 27 as in the embodiment in accordance with FIG. 4.

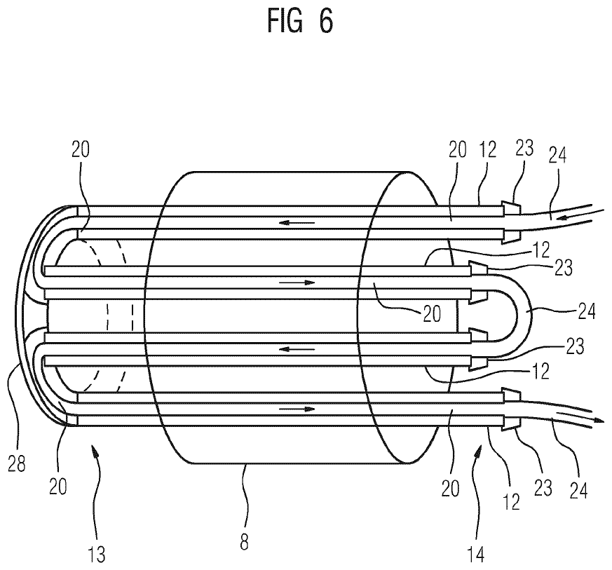

An arrangement for realizing a return channel incorporating teachings of the present disclosure for the flow of the cooling fluid is represented in FIG. 6. FIG. 6 shows the electric motor 10 with the stator/rotor block 8 penetrated by the conductor bars 12 of the stator 11 in a greatly simplified manner and omitting the cooling plates 16 and circuit boards 15. The conductor bars 12 open at one end into a short-circuiting ring 38 connecting them. The short-circuiting ring 38 is in this case designed such that it in turn has fluid channels 20 which are designed such that each of them connects the fluid channels 20 of two-in the simplest case adjacent-conductor bars 12 to one another. In this way, a flow is achieved in which a first conductor bar 12 represents an inflow, into which the cooling fluid thus enters on the rear face 14 of the electric motor 10, and a conductor bar 12 adjacent thereto represents the outflow, in which likewise the cooling fluid exits on the rear face of the electric motor 10. The hoses 23 at the inlet and outlet can be brought together at another location in order to achieve a cooling circuit. At this location the heat can be dissipated to the environment via a heat exchanger or heat sink. It is possible for the aforementioned elements to be designed as part of the electric motor 10. In some embodiments, the cooling circuit is present at the installation location of the electric motor 10 independently of the electric motor 10 and the electric motor 10 is connected thereto together with other devices.

Since all conductor bars 12 are heated similarly from the side of the stator/rotor block 8 and are connected similarly to the circuit boards 15, it is expedient to provide a fluid channel 20 for each of the conductor bars 12. However, in certain embodiments of the electric motor 10 the number of conductor bars 12 is high, for example 48, 72 or even 120. In the latter case, there are thus 60 outflows and 60 inflows, which have to be connected or brought together at another location and for which a water flow must be achieved, for example using a pump system. Hence it is advantageous for certain forms of embodiment of the electric motor 10 to also partially connect the fluid channels to one another on the rear face 14, as indicated in FIG. 6. To this end, the connected hose 24 is routed directly to another conductor bar 12 and is likewise connected there. Here it is expedient to connect other pairs of conductor bars than is the case in the short-circuiting ring 38, in order to achieve a meandering route of the cooling fluid. Thus the cooling fluid can be routed through 4, 6, 8 or more of the conductor bars 12 with a single inflow and a single outflow, as a result of which the structure is simplified. Depending on the need for cooling, all the conductor bars can also be connected together to form a single cooling fluid path, or else can be divided in half, into thirds or into any other fractions.

In some embodiments, a cooling fluid path is formed by multiple fluid channels connected in series and comprises the fluid channels of such conductor bars, which are separated by one, two or more intermediate conductor bars in the azimuthal sequence. If the conductor bars are numbered consecutively azimuthally, then for example a first cooling fluid path can comprise the fluid channels of conductor bars 1, 5, 9, 13, 17. while a second cooling fluid path comprises the fluid channels of conductor bars 2, 6, 10, 14, 18. a third cooling fluid path comprises those of conductor bars 3, 7, 11, 15, 19. and a fourth cooling fluid path comprises those of conductor bars 4, 8, 12, 16, 20. With these four cooling fluid paths, all fluid channels are part of a cooling fluid path. In other words, the cooling fluid paths are interconnected. If such a cooling fluid path fails due to a technical defect, this does not affect a contiguous block of conductor bars, but the lack of cooling is advantageously distributed equally over the conductor bars. The symmetry of the cooling is thus maintained.

In the previously described examples, the fluid channels may include bores or cavities in the respective elements. In some embodiments, the fluid channels are separate components and for example insert them into the conductor bars. Such fluid channels thus represent separate components. They can for example be ceramic, as a result of which electrical insulation from the conductor bar 12 is possible. In some embodiments, the fluid channel can also be manufactured from other materials, for example including metallic materials. In this case, electrical conduction from the conductor bar 12 to other elements must be prevented, for example by using plastic hoses to conduct water.

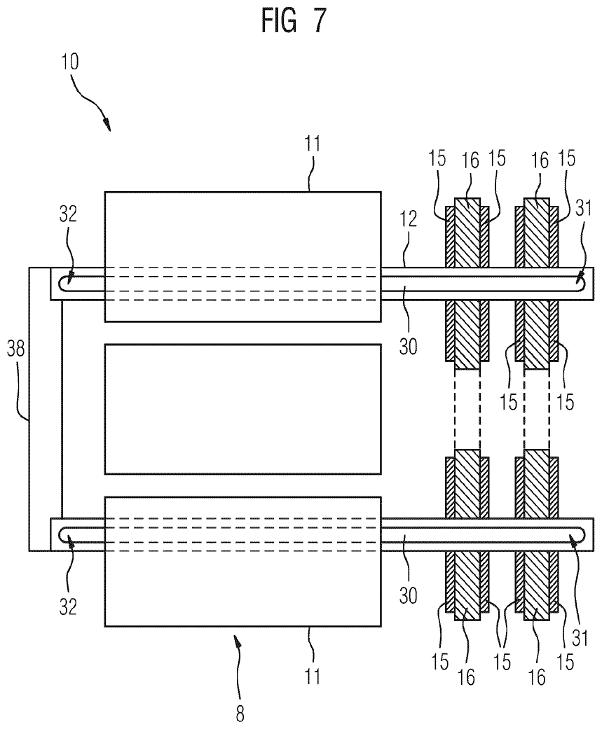

In some embodiments, open fluid channels 20, through which a cooling fluid flows in one direction, the fluid channels 20 inside the conductor bars 12 can also be closed and designed as heat tubes 30. One such embodiment is shown in FIG. 7. FIG. 7 shows the electric motor 10 in a side view with the stator/rotor block 8 and the conductor bars 12. Furthermore, two cooling plates 16 with circuit boards affixed on both sides are arranged on the conductor bars 12 on the rear face 14 of the electric motor.

The heat tubes 30, 31 substantially pass through the entire length of the conductor bars. In this case they are arranged such that their evaporator-side ends 31 are located in the region between the stator/rotor block 8 as far as the cooling plate or cooling plates 16. As a result, the heat is mainly dissipated from this region, i.e. the waste heat of the power amplifiers of the inverter is carried off and waste heat from the stator/rotor block 8 is prevented from contributing to the heating of the power amplifiers on the circuit boards 15. The heat tubes 30 can for example be copper water heat tubes.

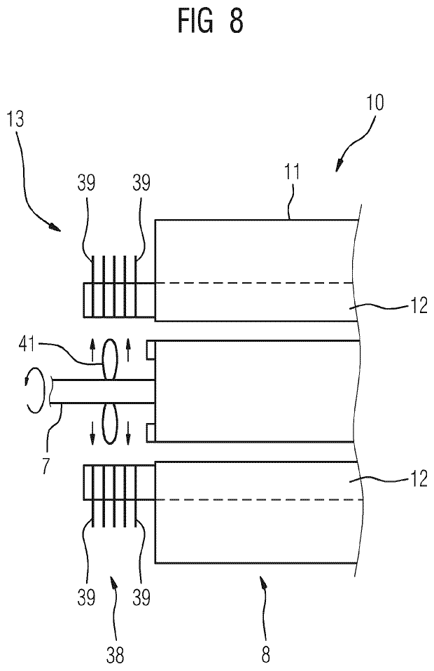

The capacitor-side end 32 of the heat tubes 30 can on the one hand be located on the rear face 14 of the electric motor 10 at an end of the conductor bars 12 facing away from the stator/rotor block 8. On the other hand, the capacitor-side end of the heat tubes 30 can also be located in the region of the short-circuiting ring 38. In both cases, recooling of the heat tubes 30 is assisted at their capacitor-side end, for example by cooling fins as air heat exchangers or another type of heat exchanger. A corresponding embodiment is represented in FIG. 8.

FIG. 8 shows a cutout of the end face 13 of the electric motor 10. In this case the stator/rotor block 8 is shown in part, as well as the conductor bars 12 protruding out of it, which end in the short-circuiting ring 38. The conductor bars 12 contain heat tubes 30, whose capacitor-side end is located in the region of the short-circuiting ring 38. The short-circuiting ring 38 itself is formed by spaced individual laminations 39 in the form of embodiment in FIG. 9. In some embodiments, the short-circuiting ring 38 can also be formed from axially assembled individual laminations or can simply be a solid ring. It may be contacted with the conductor bars by the same high-pressure process with which the hollow conductors are fixed in the stator laminated core.

In some embodiments, there are spaced individual plates 39, as represented in FIG. 8, the short-circuiting ring 38 has a significantly larger surface compared to a solid short-circuiting ring. This surface serves as a heat sink for the heat tube 30 in the conductor bars 12. Furthermore, this embodiment can also be advantageous for avoiding eddy currents. A radial cooling air flow is generated by a fan 41 arranged radially within this short-circuiting ring 38 of the stator 11 on the motor shaft 7. This passes through the gaps between the individual plates 39 and ensures improved heat dissipation from the short-circuiting ring 38.

The cooling of the short-circuiting ring 38 can be open (heat exchange with the ambient air, for example via air ducts in the stator), or can be effected as a closed cooling circuit with a secondary cooling device. To this end, air-to-air cooling units via tube or plate coolers or air-to-liquid cooling units via jacket or top-mounted coolers can for example be used.

### LIST OF REFERENCE CHARACTERS

7 Motor shaft
8 Stator/rotor block
9 Motor axis
10 Electric motor
11 Stator
12 Conductor bar
13 End face
14 Rear face
15 Circuit board
16 Cooling plate
17 Shoe
18 Connecting element
20 Fluid channel
23 Hose connection
24 Hose
25, 28 Sleeve
26 Recess
27 Threaded bar
38 Short-circuiting ring
30 Heat tube
31 Evaporator-side end
32 Capacitor-side end
39 Lamination
41 Fan
421 Contact points
422 Semiconductor switches

What is claimed is:

1. An electric motor comprising:
a stator with a plurality of bar-shaped field conductors;
an inverter with one or more parallel power components for controlling each of the field conductors, wherein the inverter comprises a controller to generate control signals for the power components;
wherein
power amplifiers are arranged on a plurality of circuit boards;
the individual circuit boards are arranged on one or more cooling plates;
the one or more cooling plates are arranged in mechanically active connection with the field conductors;
a cooling device including a fluid line routed at least in part inside one of the field conductors.

2. The electric motor as claimed in claim 1, further comprising a respective fluid line for each of the field conductors routed at least in part inside the respective field conductor.

3. The electric motor as claimed in claim 1, wherein at least a region through which the fluid line is routed in the field conductor is located axially between one of the one or more cooling plates and a stator/rotor block.

4. The electric motor as claimed in claim 1, further comprising a short-circuiting ring on a side of the electric motor facing away from the one or more cooling plates for an electrical connection of the field conductors; and
wherein the fluid lines for at least two of the field conductors are connected to one another in the short-circuiting ring.

5. The electric motor as claimed in claim 4, wherein the fluid lines for at least two of the field conductors are connected to one another on a side of the electric motor facing away from the short-circuiting ring.

6. The electric motor as claimed in claim 1, wherein:
the fluid line is formed in part by a threaded rod screwed into an end of a field conductor; and
the fluid line continues into the field conductor.

7. The electric motor as claimed in claim 6, wherein at least one of the one or more cooling plates is slid onto the threaded rod in alternation with elements for axial positioning.

8. The electric motor as claimed in claim 1, wherein the fluid line comprises a metallic material.

9. The electric motor as claimed in claim 1, where in the fluid line is formed at least in part by a cavity or bore in the field conductor.

10. The electric motor as claimed in claim 1, wherein the fluid line includes a heat tube arranged entirely inside one of the field conductors and/or a short-circuiting ring connected to the field conductor.

11. The electric motor as claimed in claim 10, wherein:
a capacitor-side end of the heat tube is arranged in the short-circuiting ring; and
the short-circuiting ring comprises spaced laminations.

12. The electric motor as claimed in claim 1, wherein the circuit boards comprise a circle or a ring sector.

13. The electric motor as claimed in claim 1, wherein the cooling plate is arranged perpendicular to an axis of the electric motor.

14. The electric motors as claimed in claim 1, operable to control each of the field conductors with a separate phase.

15. The electric motor as claimed in claim 1, wherein the inverters generate an A/C voltage with an amplitude of 200 V or less.
